(19) United States
(12) Patent Application Publication
(10) Pub. No.: US 2008/0294531 A1
(43) Pub. Date: Nov. 27, 2008

(54) Digital Audio and Audiovisual File System and Method

(76) Inventor: Shary Nassimi, Malibu, CA (US)

Correspondence Address: BOND, SCHOENECK & KING, PLLC, ONE LINCOLN CENTER, SYRACUSE, NY, 13202-1355, US

(21) Appl. No.: 12/123,565

(22) Filed: May 20, 2008

Related U.S. Application Data
(60) Provisional application No. 60/939,162, filed on May 21, 2007.

(51) Int. Cl. G06Q 30/00; G06F 17/30; H04N 7/16

(52) U.S. Cl. 705/26; 707/10; 726/32; 707/E17.001

(57) ABSTRACT

A system and method for allowing the owners of audio and/or audiovisual files to resell or purchased used content. The system provides for access via the internet and allows a user to upload or download content. To ensure against illicit copying of content, the system preferably includes a verification software package that must be downloaded onto the audio and/or audiovisual file player from which the user is attempted to resell content. The files uploaded to system are then made available for repurchase by another user. When the file is resold to another user, the file is removed from the available content list so that only the original audio and/or audiovisual file is ever transferred from one user to another user.

### CROSS-REFERENCE TO RELATED APPLICATIONS

The present application claims priority to U.S. Provisional Patent Application No. 60/939,162, filed on May 21, 2007.

### BACKGROUND OF THE INVENTION

1. Field of the Invention

The present invention relates to digital audio and audiovisual files and, more specifically, to a system and method for purchasing and selling digital audio and audiovisual files.

2. Description of the Related Art

With the advent of the internet and availability of audio and audiovisual content in digital formats, users are able to purchase or license digital files containing their favorite music, movies, television shows, etc. The digital files may be stored and played in desktop computers, laptop system, cellular telephones, and even in portable devices designed specifically for playing audio and audiovisual content. The popularity of devices such as the iPod™ line of products, available from Apple, Inc. of Cupertino, Calif., and other audio and audiovisual content devices, such as MP3 players, has led to an increase in online music sales and a decrease in sales at traditional, brick-and-mortar music stores. For example, consumers can purchase music files by the song, or by entire albums, at set prices and then downloaded the files directly to a player, a computer, or even a cell phone. A song typically costs about $1, whereas a traditional album with multiple songs can cost around $10 or more.

Unlike traditional formats for music and audiovisual content, such as CDs and DVDs, a digital file may not be easily resold or transferred to another person. Due to the ease with which digital audio and audiovisual files may be illicitly copied without the permission of the copyright owner(s), such content is usually provided with copyright protection or encryption software that prevents the duplication of the files. The owner of a particular audio and audiovisual file is therefore unable to take advantage of the right to resell or transfer the particular work as is the case with a tangible CD or DVD. As a result, when the owner of a particular audio and audiovisual file is tired of listening the particular music or watching the motion pictures, there is no way to recoup the costs of purchasing the content, such as by reselling the content to a brick-and-mortar music store that purchased used CDs and DVDs and resells the content to others.

### BRIEF SUMMARY OF THE INVENTION

It is therefore a principal object and advantage of the present invention to provide a system and method for allowing the owners of digital audio and audiovisual files to resell or transfer the files to others.

It is an additional object and advantage of the present invention to provide a system and method for allowing the owners of digital audio and audiovisual files to resell or transfer the files to others using the internet.

It is a further object and advantage of the present invention to provide a system and method for allowing the owners of digital audio and audiovisual files to resell or transfer the files to others using the internet without creating illicit copies of copyrighted works.

In accordance with the foregoing objects and advantages, the present invention provides an online file swapping system comprising a user connectivity module programmed to allow remotely located users to access the system via the internet. The system further comprises a file transfer module programmed to allow remote users to transmit and receive audio and audiovisual files through the internet connectivity module. The system also comprises a file deletion module programmed to ensure that no copies of the audio and audiovisual files transmitted and received by users are retained at the source. The file deletion module may include a verification sub-module that is downloadable by the user and resides on the electronic device from which the audio and audiovisual files are provided, or to which the audio and audiovisual files are sent. The system additional comprises a trading module for purchasing audio and audiovisual files and reselling used audio and audiovisual files. The system of the present invention is not limited to audiovisual files, and thus may be used with any digital content, including applications.

### BRIEF DESCRIPTION OF THE DRAWINGS

The present invention will be more fully understood and appreciated by reading the following Detailed Description in conjunction with the accompanying drawings, in which:

FIG. 1 is schematic of the modules of an exemplary system according to the present invention.

FIG. 2 is a flowchart depicting an exemplary method of according to the present invention.

### DETAILED DESCRIPTION OF THE INVENTION

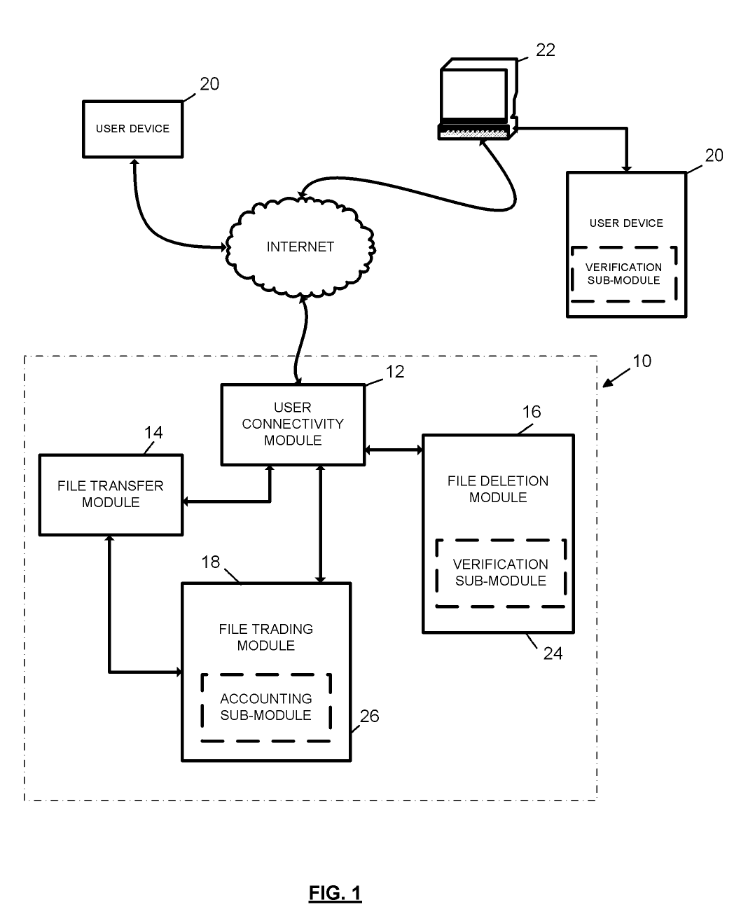

Referring now to the drawings, wherein like reference numerals refer to like parts throughout, there is seen in FIG. 1 an online file swapping system 10 comprising a user connectivity module 12, a file transfer module 14, a file deletion module 16, and a trading module 18, all of which may be programmed into a computer or other internet access device according to conventional methods. A user device 20 may interconnect with system 10, either directly or through a user host device 22. In a preferred embodiment, system 10 is configured to be accessed by users through the internet

It should be recognized by those of skill in the art that the various modules described herein may be programmed or implemented in any number of fashions, and as discrete modules or as part of an integral system. For example, connectivity module 12, file transfer module 14, file deletion module 16, and trading module 18 may be incorporated into a single program or provided as part of an enterprise system. The modules of system 10 thus comprise functional elements that may be implemented through any number of known computer programming architectures.

Connectivity module 12 allows remotely located users to access the system via the internet. It should be recognized by those of skill in the art that internet connectivity module 12 may comprise a conventional website having a URL allowing users to access system 10 through an internet browser directed to the particular address of the website. Internet connectivity module 12 may instead comprise an interface that may be accessed wirelessly, such as by cellular telephones, or through other portable telephonic devices, such as digital personal assistants.

File transfer module 14 allows users to transmit and receive audio and audiovisual files through user connectivity module 12. File transfer module 14 is thus programmed to send and receive data through conventional transfer protocols, such as FTP, and can recognize various audio and audiovisual files, such as MPEG, MPEG2, Windows Media Audio, Advanced Audio Coding, Adaptive Transform Acoustic Coding, MP3, and the like.

File deletion module 16 verifies that no copies of the audio and audiovisual files transmitted or received by users are retained at the source. File deletion module 16 thus ensures that the owner of audio and/or audiovisual file has in fact transferred the only existing copy of the audio and/or audiovisual file to which they have ownership rights, and has not retained any additional copies of the work. File deletion module 16 may further include a verification sub-module 20 that must be downloaded by the user to its audio and/or audiovisual electronic device prior to using system 10. Verification sub-module 24 resides on the electronic device from which the audio and audiovisual files of user will be provided, or to which the audio and audiovisual files will be sent. Verification sub-module 24 is programmed to survey the electronic device for illicit copies and destroy any retained copies of the content transferred to system 10 immediate after the user transfers a file. Verification sub-module 24 may then transmit a signal or command to system 10 indicating that a proper transfer has been made, thereby allowing the user to be credited by system 10 for making the particular transfer.

Trading module 18 is programmed to track which files are uploaded to system 10 by a user, or downloaded by a user from system 10. For example, trading module 18 may be programmed to generate a list of files available for purchase and provide it to connectivity module 12 for display to a user. Each file is made available for repurchase by another single user, and removed from the list of available content once it is purchased. In other words, system 10 does not allow an uploaded file to be resold to more than one other user.

Trading module 18 may further include an accounting sub-module 26 that is programmed to track user account information and record the transactions made by particular users of system 10. It should be recognized by those of skill in the art that accounting sub-module 26 may comprise an online account established by a user and include personal information, such as a user name, password, account history, payment information (such as credit card data), mailing address, email address, etc. for establishing the identity of each user and allowing for commercial sales transactions.

Trading module 18 is further programmed to accept payment from a user for items selected by the user from the list of available content on system 10. Trading module 18 may further be programmed to provide a user with credit in accounting sub-module 26 for files transferred by the particular user to system 10, and then add any such files to the list of available content on system 10. Trading module 18 and accounting sub-module 26 of system 10 is preferably programmed to pay a user a first fixed amount for each file supplied to system 10, and charge a user a second, fixed amount for each file purchased to system 10. The first fixed amount is preferably a non-cash credit toward future purchases of available content by the user. A user may thus trade in multiple files and accumulate a credit toward the purchase of new content available from system 10. The second fixed amount is preferably a cash amount to be paid by the user. Payment may be effected by off-setting any credits against the amount due, and then charging the user for the difference, such as by accepting a credit card supplied by user or using an electronic payment service, such as PayPal™ available from eBay, Inc. of San Jose, Calif. For example, a user may receive a credit of $0.10 for each file transferred to system 10, and charged $0.50 for each file purchased from system 10.

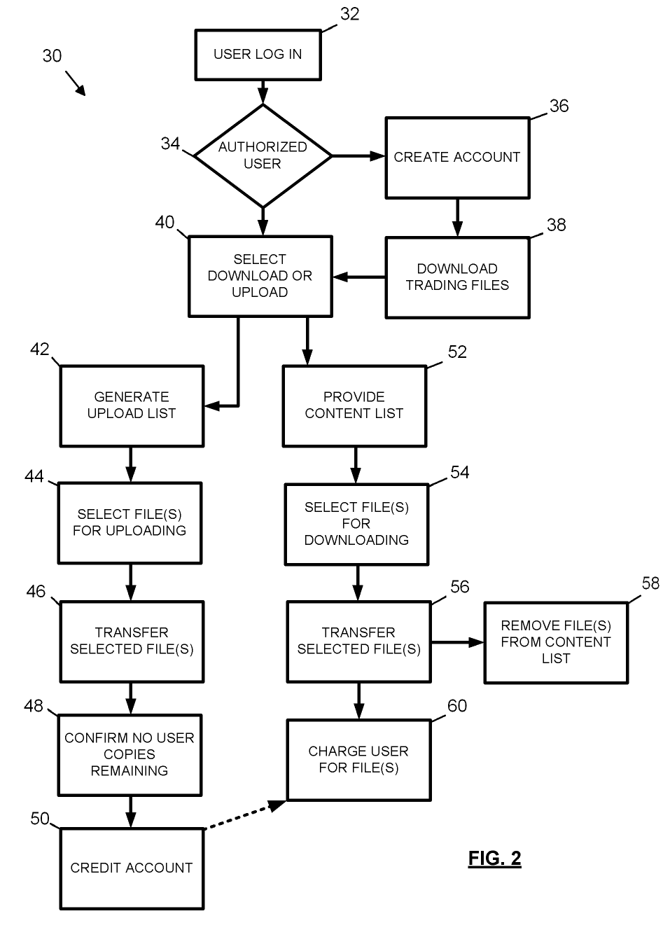

FIG. 2 depicts a method 30 of selling, trading or swapping used audio and/or audiovisual files according to the present invention. The first step of method 30 involves a user logging into 32 or establishing a connection with system 10. A check is performed 34 to determine whether the user is authorized to use system 10. If the user is not a previously authorized user of system 10, the user is prompted to create a trading account 36 and enter any required personal information. User may also be required to download one of more electronic files 38 to the user's electronic audio and/or audiovisual file player that are required for using system 10, such as verification sub-module 20. Once a user has established an account with system 10, or is found to have one at step 34, the user is allowed to choose whether he or she want to download or upload files 40.

If the user opts to upload files at step 40, system 10 communicates with the user's audio and/or audiovisual file content device to generate a list of available files for uploading 42 to system 10. Once the user has selected the files 44 to sell to system 10, the files are transferred 46 to user device 20. Verification sub-module 24 then confirms 48 that no illicit copies remain on user device 20. Once verification sub-module 24 confirms that the file was properly transferred and no copies remain, the user's account is credited 50 with the appropriate amount.

If the user instead opts to download files at step 40, trading module 18 provides the user with a list of available content 52. It should be recognized by those of skill in the art that the content may be sorted according to type of file, such as audio or audiovisual, or further sorted according to conventional genre classification, such as hard rock, popular, action, comedy, etc. Alternatively, the user may include a designation or preferred content in his or her user profile, thereby pre-selecting what content will be presented. The user is then allowed to select content for downloading 54, and system 10 transfers the selected files 56 to user. At the same time, the system 10 removes the files from the content list 58, thereby preventing another user from transferring the same file and ensuring that no additional copies of the files are created. The user is then charged the appropriate amount 60, minus any existing credits in the user's account.

It should be recognized by those of skill in the art, that the steps of method 30 are not exhaustive and may be performed in other ways. For example, payment for files transferred from system 10 by a user may be obtained prior to the actual transfer of the files. Method 30 may be also used to transfer any forms of digital files, such as application software, and is not intended to be limited to audio or audiovisual files.

What is claimed is:

1. A system for allowing an owner of a digital file to resell or purchase previously owned files, comprising:
a first module programmed to transfer said file between an owner device and the system;
a second module programmed to verify that no copies of the file remain on the user device or the system.

2. The system of claim 1, wherein said second module resides at least in part on said owner device.

3. The system of claim 2, further comprising a third module programmed to create a list of files on the user device that are available for transfer.

4. The system of claim 3, wherein said third module is programmed to create a list of files on the system available for transfer.

5. The system of claim 4, wherein said third module is programmed to allow the owner to select which files are to be transferred.

6. The system of claim 5, further comprising a fourth module programmed to track the transfer of files between the owner and said system.

7. The system of claim 6, wherein said fourth module is programmed to credit or charge the owner a predetermined amount based on the transfer of files between the owner and said system.

8. The system of claim 7, wherein said fourth module is further programmed to obtain payment from the owner for charges associated with the transfer of files between the owner and said system.

9. A method for allowing an owner of a digital file to resell or purchase previously owned files, comprising the steps of:
generating a list of files available for transfer from a device of the owner;
allowing the owner to select the files to be transferred from the device;
transferring the selected files from the device;
confirming that no copies of the transferred files are retained on the device; and
providing the owner with compensation for the transferred files.

10. The method of claim 9, further comprising the steps of:
generating a list of files available for transfer to the device of the owner;
allowing the user to select the files to be transferred to the device
transferring the selected files to the device of the owner;
confirming that no copies of the transferred files are retained; and
obtaining compensation from the owner for the transferred files.

11. The method of claim 10, wherein the step of confirming that no copies of the transferred files are retained by the owner comprises scanning the device for copies of the transferred files.

12. The method of claim 11, wherein the step of providing the owner with compensation for the transferred files comprises providing the owner with a predetermined amount of credit in an account.

13. The method of claim 11, wherein the step of obtaining compensation from the owner for the transferred files comprises completing a payment transaction.

14. The method of claim 12, wherein the step of obtaining compensation from the owner for the transferred files further comprises offsetting amounts due with credit in the account of the owner.
